(19) United States
(12) Patent Application Publication
(10) Pub. No.: US 2011/0244254 A1
(43) Pub. Date: Oct. 6, 2011

(54) Anticorrosion coatings with reactive polyelectrolyte complex system

(76) Inventors: Zhiqiang Song, Newton, CT (US); Ted Deisenroth, Brookfield, CT (US)

(21) Appl. No.: 13/048,118

(22) Filed: Mar. 15, 2011

Related U.S. Application Data
(60) Provisional application No. 61/367,641, filed on Jul. 26, 2010.
(60) Provisional application No. 61/318,838, filed on Mar. 30, 2010.

(51) Int. Cl. B32B 15/04; B01J 43/00; B05D 3/00; B05D 3/10

(52) U.S. Cl. 428/457; 521/28; 427/331; 427/337

(57) ABSTRACT

The present application is directed to anticorrosion coatings on metal substrates. In particular the coatings are especially suitable for metal containing medical devices and implants. The anticorrosion coatings comprise a combination of anionic and cationic polyelectrolytes which when applied to a metal substrate form a complex. In addition to cationic and anionic functionality, the polyelectrolytes also possess additional functionality which allows for further reacting to form covalent bonds between the anionic and cationic polyelectrolytes. The formed complex once applied to the metal substrate surface provides improved corrosion resistance, protection from metal ion release and improved mechanical properties.

This application claims the benefit of U.S. Provisional Application Nos. 61/367,641, filed Jul. 26, 2010 and 61/318,838, filed Mar. 30, 2010 herein incorporated entirely by reference.

### FIELD OF THE INVENTION

The present invention relates to anticorrosion coatings on metal substrates. In particular the coatings are especially suitable for metal containing medical devices and implants. The anticorrosion coatings comprise a combination of anionic and cationic polyelectrolytes which when applied to a metal substrate form a complex. In addition to cationic and anionic functionality, the polyelectrolytes also possess additional functionality which allows for further reacting to form covalent bonds between the anionic and cationic polyelectrolytes. The formed complex once applied to the metal substrate surface provides improved corrosion resistance, protection from metal ion release and improved mechanical properties.

### BACKGROUND

Metals are important materials widely used in various applications covering automotive, marine and medical devices and implants. Metal corrosion is a serious problem as it affects and eventually destroys integrity of metal structures. It has been estimated that the total annual direct cost of corrosion in the United States is about $276 billion, about 3.1% of the gross domestic product [Koch, G. D., Brongers, M. P. H., Thompson, N. G., Virmani, Y. P. and Payer, J. H., “Corrosion Cost and Preventive Strategies in the United State”, Perform. 7 (suppl.), 2-11 (2002)].

Corrosion resistant metals used in medical devices or implants present particular challenges. According to literature (Black, J., in “Biological Performance of Materials: Fundamentals of Biocompatibility”, Mercel Decker Inc, New York, 1992), the electrical potential of metallic biomaterial can range from −1 to 1.2 V vs. SCE (saturated calomel reference) in the human body. The high potential in the human body can cause localized pitting corrosion and crevice corrosion even for well known corrosion resistant metals such type 316L stainless steels (SS316L) which show a pitting breakdown potential ranging from 0.4 to 0.8 V vs. SCE. See “An assessment of ASTM F2129 Electrochemical testing of small medical implants—lessons learned”, S. N. Rosenboom and R. A. Corbett, NACE Corrosion 2007 Conference & Expo, Paper No. 07674 and “Pitting corrosion behavior of austentic steels—combining effects of Mn and Mo additions”, A. Pardo et. al, Corrosion Science 50 (2008) 1796-1806.

Most anticorrosion coatings in the prior art act as electrical barrier for electronic and ionic migration at the metal surface. Protection of metals from corrosion is much more difficult when they are used in highly aggressive environments such as sea water and human body which consist of aqueous electrolyte solutions containing large amount of highly corrosive species such as chloride ions. Small defects in the coating may rapidly lead to deterioration of the coating-metal interface and cause peeling and flaking of the coating.

Coatings formed from polyelectrolytes are known to provide anticorrosion protection. For example, U.S. Publication No. 2004/0265603A1 discloses an anticorrosion polyelectrolyte multilayer (PEM) coating comprising a polyelectrolyte complex of two oppositely charged strong polyelectrolytes.

The disclosed PEM coatings are made by layer-by-layer (LbL) alternative deposition of poly(diallyldimethylammonium chloride) (PDAD), a strong cationic (positively charged) polyelectrolyte, and poly(styrene sulfonate) (PSS), a strong anionic (negatively charged) polyelectrolyte. Although the PEM coatings disclosed in U.S. Publication No. 2004/0265603A1 suppress localized pitting corrosion of stainless steel, additional improvement for controlling general corrosion below E_{b} is desired.

There are a number of references which teach various PEM systems but do not suggest their use as corrosion protective coatings. For example, Kharlampieva, E. et al. Macromolecules 2003, 36, 9950 disclose PEM deposition onto hydrophilic Si crystals. The PEM system taught is a cationic copolymer of acrylamide and dimethyldiallylammonium chloride, a strong cationic polyelectrolyte and poly(methacrylic acid), a weak anionic polyelectrolyte.

Regine v. Klitzing, Phys. Chem. Chem. Phys., 2006, 8, 5012-5033 discloses deposited multilayers assembled from a copolymer of poly(4-styrenesulfonic acid-co-maleic acid), a strong anionic and weak anionic polyelectrolyte deposited in alternation with poly(allylamine hydrochloride), a weak cationic polyelectrolyte onto silicon wafers.

Tjipto et. al, Langmuir 2005, 21, 8785-8792 teaches Poly(styrenesulfonate acid-co-maleic acid) assembled into multilayer thin films with polyallylamine hydrochloride (a weak cationic polyelectrolyte) on silicon wafers, quartz and glass

It has been found, however, that there is still a need for greater corrosion protection of metal, especially at the free corrosion near the open circuit potential (OCP) or the corrosion potential (E_{cor}) and to accomplish this safely, conveniently and economically without deterioration of mechanical stability. There is also a need for anticorrosion coating on metallic medical devices and implants which reduce metal ion release to surrounding body environment which release, ultimately causing pain to the patient.

### SUMMARY OF THE INVENTION

Accordingly the object of the present invention is to provide compositions which when applied onto metal give a coating which is characterized by improved corrosion protection. A further objective of the invention is to control corrosion at potential lower than the pitting breakdown potential (E_{b}) and especially the free corrosion near the open circuit potential (OCP) or the corrosion potential (E_{cor}).

Additional objectives of the present invention are to provide coating compositions which are mechanically stable and do not blister or peel when exposed to severe environments; to provide coatings which display some self-assembly characteristics which give even, smooth, organic coatings which are easily applied via layer by layer alternative dipping, spraying or coating without intervening drying steps; to reduce the number of deposition layers in PEM systems while still maintaining sufficient corrosion protection and finally to provide uniform, excellent adhesion which follow the contours and irregularities of the substrate, properties which are particularly valuable in coatings for medial devices and implants.

Accordingly the invention described below:

The invention encompasses several embodiments elaborated below:

A polyelectrolyte complex, a coated metal substrate comprising the polyelectrolyte complex, a method of protecting a metal substrate from corrosion, a kit of parts for the making or manufacture of an anticorrosion coating on a metal substrate and the use of the polyelectrolyte complex as an anticorrosion coating for a metal substrate, especially in medical devices and implants

Accordingly the polyelectrolyte complex comprises polyelectrolytes (A) and (B), wherein polyelectrolyte (A) is an anionic polyelectrolyte containing strongly and negatively charged groups (Aₛ) and weak acid groups (A_{w}) and polyelectrolye (B) is a cationic polyelectrolyte containing strongly and positively charged groups (Bₛ) and weak base groups (B_{w}),

wherein groups (A_{w}) and groups (B_{w}) are reactible with each other to form covalent bonds.
The coated metal substrate comprises a
a) metal substrate and
b) a coating on said substrate comprising a polyelectrolyte complex which complex comprises polyelectrolytes (A) and (B), wherein polyelectrolyte (A) is an anionic polyelectrolyte containing strongly and negatively charged groups (Aₛ) and weak acid groups (A_{w}) and
polyelectrolye (B) is a cationic polyelectrolyte containing strongly and positively charged groups (Bₛ) and weak base groups (B_{w}),
groups (A_{w}) and groups (B_{w}) are reactible with each other to form covalent bonds and
c) optionally, further comprising an antimicrobial agent.

The invention also embodies a method of protecting a metal substrate from corrosion wherein the method of protecting the metal substrate from corrosion comprises

i.) applying to the substrate a polyelectrolyte (A) and a polyelectrolyte (B) to form complex, wherein
(A) is an anionic polyelectrolyte containing strongly and negatively charged groups (Aₛ) and weak acid groups (A_{w}) and
(B) is a cationic polyelectrolyte containing strongly and positively charged groups (Bₛ) and weak base groups (B_{w}), wherein
A_{w}) and (B_{w}) are reactible with each other to form covalent bonds;
ii.) optionally, applying an after-treatment of the applied complex to form covalent bonds between groups (A_{w}) and groups (B_{w}),
and
iii.) optionally, contacting the metal substrate, incorporating into or onto either the polyelectrolyte (A) and/or polyelectrolyte (B) or
contacting the applied complex with an antimicrobial agent.

A kit of parts is further envisioned for the manufacture or making of the coated corrosion resistant metal substrate, comprising

a first part (A) comprising an anionic polyelectrolyte containing strongly and negatively charged groups (Aₛ) and weak acid groups (A_{w}) and a second part (B) comprising a cationic polyelectrolyte containing strongly and positively charged groups (Bₛ) and weak base groups (B_{w}),
wherein groups (A_{w}) and groups (B_{w}) are reactible with each other to form covalent bonds,
and
an optional third part comprising an antimicrobial agent,
which parts when applied to the metal substrate form a coated metal substrate as described above.

The corrosion resistant coatings of the invention have numerous applications. Envisioned applications are any metal surface needing protection from corrosion. However, some specific application that especially come to mind are steel pipes carrying petroleum and natural gas which must be protected from catastrophic corrosion failure, metal surfaces exposed to very corrosive environments such as desalination plants. Metallic medical device and implants are especially envisioned. Further, uses of the corrosion resistant coating of the invention are electronic equipments and devices, printed circuit boards, batteries, jewelry and automotive coatings.

### DETAILED DESCRIPTION OF THE INVENTION

The term “comprising” for purposes of the invention is open ended, that is other components may be included. Comprising is synonymous with terms such as including and containing.

Metal Substrate

The metal substrate includes any materials which have a tendency to corrode. For example, the metals selected from the groups I A, IIA, IIIA, IVA, VA, VIA, IIIB, IVB, VB, VIIB, VIIB, VIII B, IB, IIB, of the periodic table. Metal includes alloys.

Typical metal substrates may be selected from the group consisting of iron, aluminum, magnesium, copper, titanium, beryllium, silicon, chromium, manganese, cobalt, nickel, palladium, lead, cerium, cadmium, molybdenum, hafnium, antimony, tungsten, tantalum, vanadium, mixtures and alloys thereof.

Preferably the metal substrate is steel, aluminum, titanium, chromium cobalt, chromium, mixtures or alloys thereof. Most preferably the metal substrate is a steel alloy such as stainless steel (316L), aluminum, titanium, titanium alloy or chromium-cobalt alloy.

The metal substrate may be any shape or form. The substrate of course, includes not only planar surfaces but three-dimensional substrates. For example, the substrate may be a flake, tube, pipe or metal parts.

Preferably the metal substrate is at least a part of a medial device or implant.

The metal coating, method of protecting the metal substrate or kit of parts are especially suitable for metal substrates which comprise at least a part of a medical devices or implant.

Polyelectrolyte

Polyelectrolytes are known to be polymeric substances. The polyelectrolytes may be either natural (protein, starches, celluloses, polypeptides), modified natural or synthetically derived polymers. The natural polymers may be modified natural polymers such as cationically modified starch or cationically modified cellulose. The polyelectrolytes bear a plurality of charged units arranged in a spatially regular or irregular manner. The charged units may be either anionic or cationic.

Preferrably the polyelectrolytes are synthetically derived.

The synthetically derived polyelectrolyes may be homopolymers or copolymers formed from monomers, condensants or oligomers.

The monomers are generally ethylenically unsaturated molecules capable of polymerization. The monomers once polymerized give repeat units that are charged but may additionally contain neutral repeat units (e.g. positive and neutral; negative and neutral; positive and negative; or positive, negative and neutral).

Copolymers are defined as macromolecules or polymers having a combination of two or more repeat units.

The present polyelectrolytes may be virtually any type of molecular architecture. They may be linear, random, grafted, branched, dentritic, star, block or gradient polymers.

Polyelectrolytes can be described in terms of charge density (meg/g). Suitable polyelectrolytes can have a total charge density (q) of from about 0.5 to about 60 meq/g, preferably from about 1.0 to about 40 meq/g, more preferably from about 2 to about 30, and most preferably from about 3.0 to about 20.

The total charge density includes contribution from the charged groups as well as potentially chargeable groups of the weak electrolyte groups which become charged depending on pH. Thus, the total charge density is the sum of charge density (qₛ) contributed from strong electrolyte groups and the charge density (qₛ) contributed from the weak electrolyte groups: q=qₛ+q_{w}. Suitable polyelectrolytes containing both strong and weak electrolyte groups for our invention can have a q_{w}/qₛ ratio of from about 1/99 to about 99/1, preferably from about 5/95 to about 95/5, more preferably from about 10/90 to about 90/10, and the most preferably from about 20/80 to about 80/20.

The molecular weight of the synthetic or natural polyelectrolyte (A) or (B) (either the cationic or anionic (A) and (B)) is typically about 1,000 to about 10,000,000 Daltons, preferably about 100,000 to about 3,000,000, most preferably about 5,000 to about 1,000,000.

The molecular weight specified is a preferably weight average molecular weight (M_{w}) which can be determined by a typical light scattering method or a GPC (gel permeation chromatography) method.

Polyelectrolyte (A) Containing Groups Aₛ and A_{w}

(A) is an anionically charged polyelectrolyte. (A) contains both strongly and negatively charged groups (Aₛ) and weak acid groups (A_{w}).

While (A) may contain other nonionic repeat units formed from nonionic monomers, the charged repeat units on (A) will preferably not include cationic repeat units.

Aₛ

Aₛ for purposes of the invention means groups which are part of a repeat unit of the polyelectrolyte (A) which are both negatively charged and strongly charged. Strong means the Aₛ groups are ones which dissociate completely in solution to give a charge density substantially independent of pH. Thus these groups will substantially retain their negative charge regardless of the pH of solution they may be dissolved or dispersed within.

Strong anionic electrolyte groups (Aₛ) are anionic groups of a dissociated strong acid. Strong anionic electrolyte groups (As) are preferably anionic groups characterized by a pKₐ value less than about 2.5.

Aₛ groups are preferably sulfate, sulfonate, phosphate, hydrogen phosphite, phosphoric acid, mixtures or salts thereof. Accordingly, a synthetic polyelectrolyte (A) may be formed from monomers containing a sulfate, sulfonic acid, phosphate, hydrogen phosphite, phosphoric acid and phosphonic acid groups which when polymerized will give repeat units containing these moieties.

Preferably Aₛ has a pKₐ of its conjugated acid less than 2.5, most preferably less than about 2.0 and especially less than about 1.0.

The Aₛ groups on the polyelectrolyte (A) most preferably are repeat units formed from monomers selected from the group consisting of styrene sulfonic acids, vinylsulfonic acid, allyl sulfonic acid, (meth)acrylamidopropyl sulfonic acid, vinyl phosphonic acid and salts thereof, especially styrene sulfonic acids and (meth)acrylamidopropyl sulfonic acid and salts thereof.

Strongly and anionically charged natural polymers are also envisioned as the (A) polyelectrolyte. For example, sulfonated polysaccharides may be produced by reacting a cyclic sultone such as 1,3-propane sultone with a polysaccharide. Phosphonated polysaccharides may be produced by reacting a polysaccharide with a cyclic phosphoric acid.

In contrast to the Aₛ groups, the term weak means A_{w} groups are not fully charged but dissociate partially in solution depending on the pH of the solution or dispersion containing the polyelectrolyte (A) containing the A_{w} moieties. The charge density of the weak anionic group is therefore pH dependent. For example, an A_{w} group will normally be more completely dissociated (ionized) at a high pH. The A_{w} group will typically be a carboxylic acid. The carboxylic group is located on the repeat units of polyelectrolyte (A) and the repeat units may be formed from monomers containing a carboxylic acid.

Preferably A_{w} has a pKₐ value ranges from about 2.0 to about 7.0, most preferably from about 3 to about 6. At a pH of the pKₐ value, half of the A_{w} will become charged. The amount of A_{w} become deprotonated or negatively charged will increase with increasing pH.

Preferably, the A_{w} group of the polyelectrolyte (A) will be part of a repeat unit formed from a monomer selected from the group consisting of (meth)acrylic acid, maleic acid or anhydride, itaconic acid or anhydride, crotonic acid and mixtures and salts thereof. (Meth) acrylic acid includes methacrylic acid and acrylic acid.

Alternatively the A_{w} on the polyelectrolyte (A) may be a carboxylated natural polymer such as a carboxylated polysaccharide.

The preferred polyelectrolyte (A) having both Aₛ and A_{w} groups are polyelectrolytes wherein the Aₛ group is a sulfonic, sulfate, phosphate, hydrogen phosphate or phosphoric acid groups, most preferably sulfonic or sulfate groups and the A_{w} group is a carboxylic acid group.

Synthetic polyelectrolytes (A) may be obtained from homopolymerization of an anionic monomer containing both groups (Aₛ) and A_{w} groups. However, most typically, a synthetic polyelectrolyte (A) will be formed from a first anionic and second anionic monomer. The first monomer will contain strongly and negatively charged groups (Aₛ) and the second monomer will contain weak acid groups (A_{w}).

Preferably the polyelectrolyte (A) is a synthetic polymer and contains repeat units formed from a first anionic monomer containing an Aₛ group wherein the first monomers are selected from the group consisting of styrene sulfonic acids, vinylsulfonic acid, allyl sulfonic acid, (meth)acrylamidopropyl sulfonic acid, vinyl phosphonic acid and salts thereof, especially styrene sulfonic acids and (meth)acrylamidopropyl sulfonic acid and salts thereof

and
a second anionic monomer containing A_{w} groups are selected from (meth)acrylic acid, maleic acid or anhydride, itaconic acid or anhydride, crotonic acid and mixtures and salts thereof, especially (meth) acrylic acid, maleic acid, itaconic acid.

Preferred synthetic polyelectrolytes (A) are poly(styrenesulfonate-co-maleic acid), poly(styrenesulfonate-co-methacrylic acid), poly(styrenesulfonate-co-acrylic acid), and poly(styrenesulfonate-co-itaconic acid).

The anionic monomers used in the polymerization may be in the acid or salt form. Polymers obtained from the acid monomer may be converted to anionic polymer salts by neutralization with a suitable base. For example, the salts of the sulfonic acids and carboxylic acids may be neutralized with an ammonium cation or a metal cation selected from the group consisting of Groups IA, IIA, IB and IIB of the Periodic Table of Elements. Preferably the salts of the sulfonic acids and carboxylic acids are salts of ammonium cations such as [NH₄]⁺ and [N(CH₃)₄]⁺, or K+ or Na+.

Polyelectrolyte (B) Containing Groups Bₛ and B_{w}

The Cationic polyelectrolyte (B) is analogous to polyelectrolyte (A) but oppositely charged.

(B) is an cationically charged polyelectrolyte. (B) contains both strongly and positively charged groups (Bₛ) and weak base groups (B_{w}).

While (B) may contain other nonionic repeat units formed from nonionic monomers, the charged repeat units on (B) will preferably not include anionic repeat units.

Bₛ

Bₛ for purposes of the invention means groups which are part of a repeat unit of the polyelectrolyte (B) which are both positively charged and strongly charged. These groups are permanent cationic groups independent of pH.

Bₛ groups are preferably quaternary ammonium, sulfonium, phosphonium, mixtures thereof or salts thereof. Accordingly, a synthetic polyelectrolyte (B) may be formed from monomers containing a quaternary ammonium, sulfonium, phosphonium groups which when polymerized will give repeat units containing these moieties.

Suitable monomers which carry Bₛ groups are for example phenyl methacrylate dimethylsulfonium nonaflate, allyl sulfonium (e.g., dimethylallyl sulfonium bromide, diallylmethyl sulfonium bromide, 2-ethoxycarbonyl-2-propenylthiophenium hexafluoroantimonate), allyl phosphonium (e.g., allyl triphenyl phosphonium bromide), diallyldimethyl ammonium chloride (DADMAC), diallyldimethyl ammonium bromide, diallyldimethyl ammonium sulfate, diallyldimethyl ammonium phosphates, diethylallyl dimethyl ammonium chloride, diallyl di(beta-hydroxyethyl) ammonium chloride, and diallyl di(beta-ethoxyethyl) ammonium chloride, dimethallyldimethyl ammonium chloride, dimethylaminoethyl (meth)acrylate methyl chloride quaternary, diethylaminoethyl (meth)acrylate methyl chloride quaternary, dimethylaminoethyl (meth)acrylate dimethylsulfate quaternary and dimethylaminoethyl (meth)acrylate benzyl chloride quaternary.

The Bₛ groups on the polyelectrolyte (B) are preferably repeat units formed from monomers selected from the group consisting diallyldimethyl ammonium chloride (DADMAC), diallyldimethyl ammonium bromide, diallyldimethyl ammonium sulfate, diallyldimethyl ammonium phosphates, diethylallyl dimethyl ammonium chloride, diallyl di(beta-hydroxyethyl) ammonium chloride, and diallyl di(beta-ethoxyethyl) ammonium chloride, dimethallyldimethyl ammonium chloride, dimethylaminoethyl (meth)acrylate methyl chloride quaternary, diethylaminoethyl (meth)acrylate methyl chloride quaternary, dimethylaminoethyl (meth)acrylate dimethylsulfate quaternary, dimethylaminoethyl (meth)acrylate benzyl chloride quaternary.

The B polyelectrolyte may be a natural polymer containing strong and cationically charged Bₛ groups. For example, quaternized chitosan and cationic starch are well known in the art.

In contrast to the Bₛ groups, the term weak in reference to B_{w} groups means these groups are not fully charged but dissociate partially in solution depending on the pH of the solution or dispersion containing the polyelectrolyte (B). The charge density of the weak base group is therefore pH dependent. For example, an B_{w} group will normally be more completely dissociated (ionized) at a low pH. The B_{w} group will typically be a primary, secondary or tertiary amine. The amine is located on the repeat unit of the polyelectrolyte (B) and the repeat units may be formed from monomers containing the primary, secondary, tertiary amine or acid addition salts thereof.

B_{w} can become positively charged when it associated with a positively charged proton H⁺ and thus the pH will affect the amount of the protonated B_{w}. The amount of B_{w} become protonated or positively charged will increase with decreasing pH.

Suitable pKₐ for the B_{w} may range from 3 to 14, preferably from about 5 to about 12, and more preferably from about 6 to about 11.

Preferably, the B_{w} group of the polyelectrolyte (B) will be part of a repeat unit formed from a monomer selected from the group consisting of diallylamine, methyldiallylamine, allylamine, methylallylamine, dimethylallylamine, and their salts, aminoalkyl (meth)acrylates such as dimethylaminoethyl (meth)acrylate, diethylaminoethyl (meth)acrylate, and 7-amino-3,7-dimethyloctyl (meth)acrylate, and their salts including their alkyl and benzyl quaternized salts; N,N′-dimethylaminopropyl acrylamide and its salts, vinylimidazole and its salts, and vinyl pyridine and its salts, vinylamine (obtained by hydrolysis of vinyl alkylamide polymers) and its salts.

Most preferably, the B_{w} group will be part of a repeat unit formed from a monomer selected from the groups consisting of diallyamine, vinylimidazole, vinyl pyridine, vinyl amine (obtained by hydrolysis of vinyl alkylamide polymers), dimethylaminoethyl (meth)acrylate and salts thereof.

Natural polymers of interest having amine functionality are for example chitosan and polylysine.

The preferred polyelectrolyte (B) having both Bₛ and B_{w} groups are polyelectrolytes wherein the Bₛ group is a quaternized ammonium, sulfonium or phosphonium group, most preferably a quaternized ammonium group and the B_{w} group is a primary, secondary or tertiary amine group.

Synthetic polyelectrolytes (B) may be obtained from homopolymerization of an cationic monomer containing both groups (Bₛ) and B_{w} groups, for example, an amine and a quaternary ammonium groups. However, most typically, a synthetic polyelectrolyte (B) will be formed from a first and second monomer. The first monomer will contain strongly and cationically charged groups (Bₛ) and the second monomer will contain weak base groups (B_{w}).

Preferably the polyelectrolyte (B) is a synthetic polymer and contains repeat units formed from a first cationic monomer containing a Bₛ group wherein the first monomers are selected from the group consisting of diallyldimethyl ammonium chloride (DADMAC), diallyldimethyl ammonium bromide, diallyldimethyl ammonium sulfate, diallyldimethyl ammonium phosphates, diethylallyl dimethyl ammonium chloride, diallyl di(beta-hydroxyethyl) ammonium chloride, and diallyl di(beta-ethoxyethyl) ammonium chloride, dimethallyldimethyl ammonium chloride, dimethylaminoethyl (meth)acrylate methyl chloride quaternary, diethylaminoethyl (meth)acrylate methyl chloride quaternary, dimethylaminoethyl (meth)acrylate dimethylsulfate quaternary, dimethylaminoethyl (meth)acrylate benzyl chloride quaternary.

and
a second cationic monomer containing B_{w} groups and the second monomers are selected from diallyamine, vinylimidazole, vinyl pyridine, vinyl amine (obtained by hydrolysis of vinylalkylamide polymers), dimethylaminoethyl (meth)acrylate and salts thereof.

Preferred synthetic cationic polyelectrolytes (B) of the present invention are copolymers of DADMAC with diallylamine.

The polyelectrolyte (B) preferably comprises at least about 1 to about 99 weight percent, most preferably about 5 to about 80 weight percent, and especially about 20 to about 60 weight percent, of Bₛ repeat units and about 1 to about 99 weight percent, preferably about 5 to about 80 weight percent, and most preferably about 20 to about 60 weight percent, one or more weak B_{w} repeat units and optionally, about 0 to about 90 weight percent of nonionic repeat units, all weights based on the total weight of polyelectrolyte (B).

The polyelectrolytes (A) and (B) are at least partially soluble in water. Partially soluble in water means 1 gram of solute is soluble per liter, preferably >10, and most preferably >50, g solute in one liter is considered as water soluble.

The complex of polyelectrolytes (A) and (B) will form an insoluble complex in water.

The layered coatings may be prepared by any means know in the art such as brushing, spraying, drop casting, spin coating, draw down, substrate immersion. However, immersion or dipping the substrate for a period of time is a simple and reproducible process providing excellent results and is a good approach for layer by layer deposition.

Thus polyelectrolyte multilayers (PEM) can be formed by a sequence wherein a substrate is conveniently immersed or dipped into a solution of a cationic polymer for a selected period of time, removed, rinsed, and then immersed or dipped into a solution of an anionic polymer for a selected period of time before being removed and rinsed. The sequence may be repeated until a film of the desired thickness is prepared.

The polyelectrolyte solution comprises an appropriate solvent. The polyelectrolytes (A) and (B) are at least partially soluble in water or polar solvents. Thus the formation of a solution or dispersion of (A) and (B) is simple to implement. The application of (A) and (B) does not require drying steps in between the layer by layer deposition. Excess application of either (A) or (B) may be removed for example, by rinsing the previously (A) coated surface with water, then continuing to build up the successive layers by successive dipping and rinsing.

When applying the polyelectrolytes ((A) and (B)) via layer by layer deposition within a solution or dispersion, the concentration of the polyelectrolyte solutions may range from about 0.01 to about 200 grams/liter, more preferably about 0.5 to about 100 and most preferably about 1 to about 10.

Preferably the coating is applied to the metal via a layer-by-layer deposition in sequence of the cationic polymer (B) and the anionic polymer (A) in solutions forming the polyelectrolyte complex on the metal substrate.

This layer-by-layer deposition in sequence may be repeated multiple times resulting in a multilayered coating.

### Post Treatment of Coating

Post heat treatment of applied complex on the metal substrate gives further improved anticorrosion and mechanical properties. The said heat treatment comprises heating the PEM coated metals at a temperature above 100° C. and below decomposition temperature of the PEM coating for a period ranging from about 1 minutes to about 24 hours. Preferably, the temperature for the heat treatment is from about 140 to about 200° C. Preferably, the heat treatment is carried out in vacuum so as to promote the crosslink (between B_{w} and A_{w}) reaction by removing possible small molecular weight byproduct such as water from the condensation reaction.

It is believed that the weak acid A_{w} and weak base B_{w} groups provide a secondary ionic and/or hydrogen bonding interaction between (A) and (B) and potential for crosslinking. The formation of covalent bonds via crosslinking, secondary ionic and/or hydrogen bonding further contribute to the stability and corrosion resistance of the coating as well as offering higher corrosion protection with fewer multiple layers.

### Antimicrobial Agent Incorporation

Suitable antimicrobial agents including antimicrobial metal agents such as silver metals, ions or complexes may further comprise the anticorrosion coating. The inventors have determined that this addition to the coating surprisingly improves corrosion protection. This corrosion protection is further elaborated in co-pending provisional application No. 61/318,838, filed Mar. 30, 2010.

The antimicrobial agent includes for example, noble metals such as silver, copper, gold, iridium, palladium and platinum. Preferably, metal ions from silver and copper with known antimicrobial activity are envisioned such as monovalent Ag(I) (or Ag⁺) and divalent Ag(II) (or Ag²⁺), silver ions, both of which are known to be excellent antimicrobial and biocide agents.

Silver ions can be incorporated into the coatings by using inorganic and/or organic silver salts. Examples of usable silver salt compounds include but are not limited to silver nitrate, silver sulfate, silver fluoride, silver acetate, silver permanganate, silver nitrite, silver bromate, silver salicylate, silver iodate, silver dichromate, silver chromate, silver carbonate, silver citrate, silver phosphate, silver chloride, silver bromide, silver iodide, silver cyanide, silver, silver sulfite, stearate, silver benzoate, and silver oxalate. Salts such as silver nitrate, silver fluoride, silver acetate, silver permanganate, silver citrate, silver salicylate have reasonable water solubility and are well suited for use in solution for treating the polymer coating on the metal substrate.

The antimicrobial agent may be selected from the group consisting of ions of silver, copper, gold, iridium, palladium and platinum. Preferably, the antimicrobial agent is a silver salt or ion.

Complex sliver ions can be prepared from a silver salt in an aqueous medium containing excessive amounts of a cationic or anionic or neutral species which are to be complexed with silver. For example, AgCl₂⁻ complex ions can be generated by placing AgNO₃ salt in an aqueous solution containing excessive amount of NaCl. Similarly, the Ag(NH₃)₂⁺ complex ions can be formed in aqueous solution by adding silver salt to excess ammonium hydroxide. The Ag(S₂O₃)₂³⁻ ions may be formed in aqueous solution by adding AgNO₃ to excess sodium thiosulfate.

Incorporation of the antimicrobial agent into the coatings of the invention can be realized either by first applying the polyelectrolyte(s) onto the metal substrate and then treating the applied coating with a solution containing antimicrobial agent, or the antimicrobial agent can be incorporated into either one of the polyelectrolytes, followed by application of the antimicrobial agent containing polyelectrolyte to the substrate.

Alternatively, the antimicrobial agent, preferably a silver salt may be applied as a salt solution to pretreat the metal substrate before application of the polyelectrolytes (A) and (B).

### EXAMPLES

Film thickness, morphology and layer-by-layer film buildup is measured using AFM and ATR-FTIR. Electrochemical methods are used to evaluate corrosion of uncoated and coated samples.

The raw materials used for the preparation of polyelectrolyte multilayer coatings are shown in Table A.

TABLE A
raw materials used for the preparation of polyelectrolyte
multilayer coatings

| | Chemical name and composition | Abbreviation | source |
|---|---|---|---|
| A1 | poly(styrenesulfonate-co-maleic acid) | PSSMA25 | Aldrich |
| | sodium salt; | | |
| | (3:1) 4-styrenesulfonic acid:maleic acid | | |
| | mole ratio, powder, M_{w} ~20,000 | | |
| A2 | Poly(styrenesulfonate sodium), | PSS70 | Aldrich |
| | M_{W} 70,000 | | |
| A6a | Poly(acrylic acid), M_{w} ~15,000 | PAA | |
| A13 | Dextran sulfate | DXS | Aldrich |
| A14 | Poly(galacturonic acid) | PGA | Aldrich |
| B2 | Poly(diallylamine-co-DADMAC), | DAA25 | CIBA |
| | 25/75 mole, 30.6% active (11zs8C6), | | |
| | M_{w} ~300,000 | | |
| B5 | Poly(allylamine)hydrochloride, | PAH | |
| | M_{w} ~15,000 | | |
| B7 | Poly(diallyldimethylammonium chloride), | pDAD | CIBA |
| | pDADMAC, Alcofix 111 M_{w} ~450,000 | | |
| B8 | Chitosan | CTS | |
| D1 | Phytic acid | PY | Fisher |
| | silver nitrate in water | AG | |

### Layer-by-Layer (LBL) Deposition of Polyelectrolyte Multilayers (PEM)

Layer-by-layer (LbL) assembled polyelectrolyte multilayer (PEM) films are prepared by cyclic sequential dipping of a metal substrate into a cationic polyelectrolyte solution (polymer B) and an anionic polyelectrolyte solution (polymer A) with deionized water rinses in between as shown by the following general procedure:
1. Dip in Polymer B solution for 10 minute;
2. Rinse in DIW for 3 minutes;
3. Dip in Polymer A solution for 10 minute;
4. Rinse in DIW for 3 minutes; record (B/A), double layer number, i
5. Stop if coated double layer number i equal to the desired number, n; otherwise go back to step 1

If n is a whole number such as n=20, the PEM coating has 20 double layers and ends with anionic polymer A as the outmost layer. If n is a whole and half number such as n=20.5, the PEM coating has 20.5 double layers and ends with cationic polymer B as the outmost layer.

### Electrochemical Corrosion Tests

A modified ASTM G5-94 reference test method for making potentialstatic and potentiodynamic polarization measurements as described below. Similar potential dynamic and potentialstatic polarization using 0.7M NaCl electrolyte solution was also used in US patent 2004/0256503A1.

The wire to be tested is placed as working electrode in an electrochemical cell containing testing electrolyte solution (0.7M NaCl in deionized water with a pH of about 6.0 or phosphate buffered saline (PBS) with a pH of 7.4), a Ag/AgCl (3M NaCl) reference electrode and a platinum wire counter electrode. The electrolyte solution in the cell is purged with high purity nitrogen gas before starting the electrochemical testing. The area of the wire dipped in the electrolyte solution is 1.0 cm². Open circuit potential (OCP) monitoring, anodic polarization scans and chronoamperometric scans are obtained using a Solartron 1287A Electrochemical Interfacer (ECI) with CorrWare software. The Electrochemical Impedance Spectroscopy (EIS) is carried out using a Solartron 1252A Frequency Response Analyzer (FRA) with a ZPlot software over the frequency (f) of 300,000 to 0.05 Hz with 5 mV AC amplitude. A series of electrochemical tests are carried out continuously in the sequence listed in Table B to test anticorrosion properties of the uncoated (also referred to as bare) and coated wires.

TABLE B
Electrochemical corrosion tests and testing conditions

| Step | Measurements |
|---|---|
| OCP-1 | Open circuit potential (OCP) monitoring 5000 sec |
| Zplot-1 | Impedance spectroscopy: AC amplitude 5 mV vs OCP |
| | frequency scan from 300 k to 0.05 Hz |
| PD-1 | Potentiodynamic polarization: sweep from −100 mV (vs OCP) |
| | to +900 mV (vs ref) at 0.1667 mV/s scan rate |
| PS-1 | Potentiostatic polarization: +600 mV/300 sec |
| OCP-2 | OCP monitoring 3000 sec |
| PS-2 | Potentiostatic polarization: +700 mV/14 h |
| OCP-3 | OCP monitoring 3000 sec |
| Zplot-2 | Impedance spectroscopy: AC amplitude 5 mV vs OCP frequency |
| | scan from 300 k to 0.05 Hz |

The PD-1 measurement provide most information about anticorrosion properties including corrosion potential, E_{corr}, corrosion current, I_{corr}, and polarization resistance, Rₚ, of free corrosion near OCP, pitting and breakdown corrosion potential, E_{b}. The PS-2 measurement tests long term durability of the coatings to withstand long term (14 hours) testing of static anodic polarization at pitting breakdown potential (700 mV) of bare type 316 stainless steel. In case the pitting breakdown occurs during the PS-2 test, the time it begins (t_{b}) is reported.

The traditional Tafel fit of the polarization scans near E_{oc} using CorrView software yields data of corrosion current (I_{corr}, μA/cm²), corrosion potential (E_{corr}, mV), and beta Tafel constants Ba and Bc. The polarization resistance can then be calculated using Stern-Geary relationship:

Rₚ=(Ba*Bc)/[2.303*(Ba+Bc)*I_{corr}]

In general, the corrosion potential (E_{corr}) is slightly lower than, but close to, the open circuit potential (E_{oc}).

The EIS analysis (Zplot-1) just before the PD-1 measurement gives information about free corrosion properties near the open circuit potential (OCP). The polarization resistance is given by the difference of measured impedance (Z) at sufficiently low and high frequencies (f). (Impedance Spectrosopcpy: Theory, Experiment, and Applications, Edited by E. Barsoukov and J. R. MacDonald, published by John Wiley & Sons, New Jersey in 2005, page 344)

Rₚ=Z(f→0)−Z(f→∞)

As the value of the impedance at high frequency is usually negligible compared to that of the impedance at low frequency, the value of the polarization resistance is close to the impedance at low frequency. In the present study, data of the impedance at 0.05 Hz, Z(0.05 Hz) measured in Zplot-1 testing, is used to compare corrosion resistance of different samples. Similar to Rₚ, a high Z(0.05 Hz) value indicate high corrosion resistance.

### Example 1

### PEM2 Coatings with 20 Double Layers of Polymer A1 and Polymer B2 (16zs200DWH)

Vacuum arc remelted stainless steel 316LVM (ASTM F138 chemistry) wires (1.25 mm in diameter) purchased from Smallparts.com were abraded with SiC (1200 grit) sand paper purchased from Fisher Scientific Co., degreased with isopropanol, and then washed with deionized water (DIW) in an ultrasonic bath for 10 minutes. Some of such cleaned wires are tested as uncoated and served as a control for comparison. Some of the cleaned wires are coated with anticorrosion polymers and tested in the same conditions.

Polyelectrolyte multilayer coatings of 20 double layers (PEM2)₂₀ of polymer A1 (poly(styrenesulfonate-co-maleic acid) sodium salt) and polymer B2 (Poly(diallylamine-co-DADMAC)) are deposited on freshly abraded and ultrasonically cleaned 316LVM stainless steel (SS316LVM) wires using the above stated layer-by-layer deposition method. The PEM2 coatings are obtained from Polymer A solution made of 10 mM poly(styrenesulfonate-co-maleic acid) sodium salt (A1) in 0.25M NaCl aqueous solution and Polymer B solution made of 10 mM Poly(diallylamine-co-DADMAC) (B2) in 0.25M NaCl aqueous solution.

PEM2-H coatings of the heat treatment are obtained by treating PEM2 coated SS316LVM wires in a 170° C. vacuum oven for 17 hours. The treated wires are rinsed with deionized water (DIW) and dried with a nitrogen stream. Uncoated SS316LVM wires are also treated in the same conditions (16zs223H) for comparison in corrosion testing.

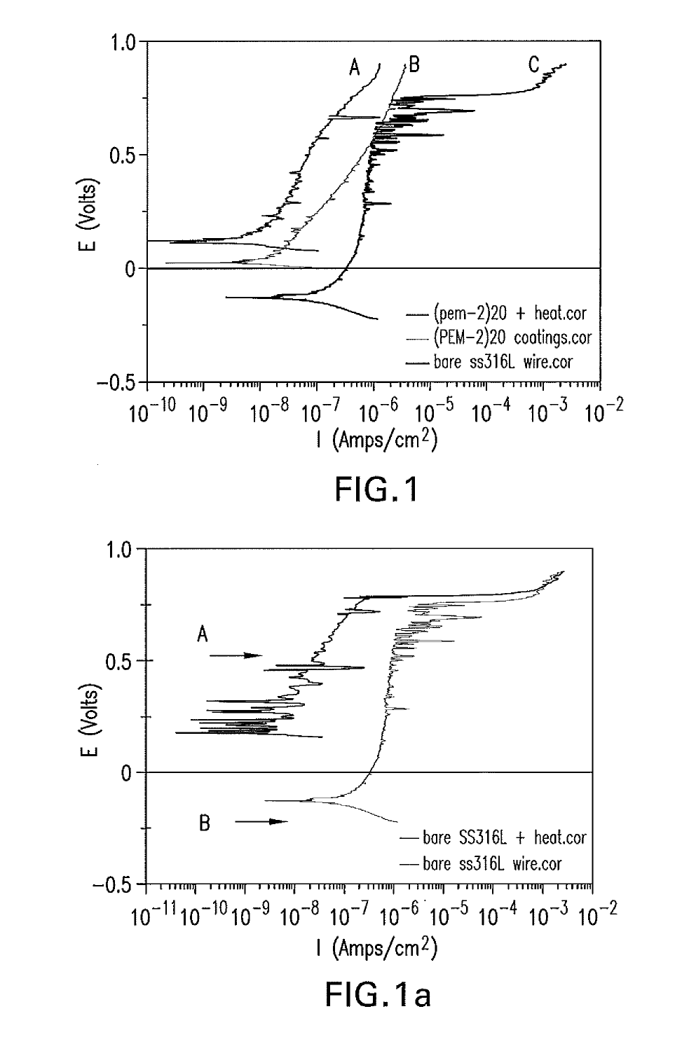

Electrochemical corrosion tests are carried out on coated and uncoated SS316LVM wires in 0.7M NaCl solution. The potentiodynamic polarization curves from the PD-1 testing are compared in FIG. 1 for bare SS316L wire (C curve), SS316L wire coated with 20 double layer PEM-2 polymers (B curve), and SS316L wire coated with 20 double layers of PEM-2 polymers and heat treated in 170° C. vacuum oven for 3 hrs (A curve). Bare SS316L wires show significant pitting corrosion with a breakdown potential E_{b} of 700 mV, beyond which a sustained corrosion current occurs. The plot for bare wire also contains random current spikes indicating meta-stable pitting before pitting breakdown at 700 mV. Wires coated with 20 double layer of PEM-2 coatings exhibit significant improvement in corrosion resistance. The meta-stable pitting is suppressed and there is no pitting breakdown up to the 900 mV potential observed. The heat treatment (170 C/3 hrs) of the PEM-2 coated wires provides significantly further improvement in corrosion resistance. The anodic polarization current for (PEM-2)₂₀ coatings with the heat treatment is significantly lower than that for (PEM-2)₂₀ coatings without the heat treatment (Figure Ex1). The free corrosion properties near OCP are also improved significantly as shown by the data in Table Ex1. With the heat treatment on the PEM-2 coated SS316LVM wires, the corrosion potential, E_{corr}, increased from 21 to 118 mV, corrosion current, I_{corr}, decreased about 5 times from about 30 to 6 nA/cm², and the polarization resistance, Rₚ, increased about 5 times from 714 to 3500 kΩ*cm².

For comparison (see comparative example 1 for more details), the heat treated (170° C. vacuum oven for 3 hours) and bare SS316LVM wires are subjected to the same electrochemical corrosion tests. The heat treatment of SS316LVM treated raised significantly the corrosion potential, E_{corr}, but did not suppress pitting corrosion breakdown. The heat treated wire had a pitting corrosion breakdown potential (780 mV) slightly higher than that (700 mV) for untreated wire.

This example demonstrated benefit of the heat treatment with polyelectrolyte multilayer coatings for anti-corrosion improvement on medical grade SS316LVM stainless steel. Significant improvement in anti-corrosion properties can be achieved by heat treatment of coated SS316LVM to promote crosslink and thus improving the coatings' protective properties.

TABLE EX 1
Data from Zplot-1, PD-1 and PS-2 tests for
SS316L wires uncoated and coated with PEM-2.

| | | Z(0.05 Hz) | E_{corr} | I_{corr} | Rₚ | E_{b} | t_{b} (700 mV) |
|---|---|---|---|---|---|---|---|
| Wire ID | coatings | KΩ*cm² | mV | μA/cm² | kΩ*cm² | mV | Hr |
| Bare SS316L | No | 30 | −128 | 0.093 | 285 | 700 | 0 |
| 16zs200DW | (PEM-2)₂₀ | 60 | 21 | 0.029 | 714 | No | >14 |
| 16zs200DWH | (PEM-2)₂₀ + | 107 | 118 | 0.006 | 3500 | No | >14 |
| | heat* | | | | | | |

*heat in 170° C. vacuum oven for 17 hours

See FIG. 1: Potentiodynamic polarization curves from the PD-1 testing, bare SS316L wire (A curve), SS316L wire coated with 20 double layer PEM-2 polymers (B curve), and SS316L wire coated with 20 double layers of PEM-2 polymers and heat treated at 170° C. for 3 hours (C curve)

### Comparative Example 1

### (Heat Treated SS316L) (16zs223H)

Uncoated bare SS316LVM wires are heat treated in a vacuum oven at 170° C. for 3 hours. For comparison, the heat treated and bare SS316LVM wires are subjected to the same electrochemical corrosion tests as in Example 1. As can be seen from Figure C1 and Table C1, The heat treatment of SS316LVM treated raised significantly the corrosion potential, E_{corr}, but did not suppress pitting corrosion breakdown. The heat treated wire had a pitting corrosion breakdown potential (780 mV) slightly higher than that (700 mV) for untreated wire.

TABLE C1
Data from Zplot-1, PD-1 and PS-2 tests for heat treated and
untreated SS316L wires.

| | | | | | | t_{b}(700 |
|---|---|---|---|---|---|---|
| | | E_{corr} | I_{corr} | Rₚ | E_{b} | mV) |
| Wire ID | reference | mV | μA/cm² | kΩ/cm² | mv | hr |
| Bare SS316L | Bare 316 | −128 | 0.093 | 285 | 700 | 0 |
| SS316L | 16zs223H | 198 | 0.016 | 1610 | 780 | 0 |
| heat treated | | | | | | |

See FIG. 1a: Potentiodynamic polarization curves from the PD-1 testing, bare SS316L wire (B curve), SS316L wire treated in 170 C vacuum oven for 3 hour (A curve)

### Example 2

### PEM2 Coatings with 20 Double Layers of Polymer A1 and Polymer B2 on Phytic Acid Treated SS316LVM Wires (16zs200PWH)

Freshly abraded and ultrasonically cleaned 316LVM stainless steel (SS316LVM) wires were immersed in a solution of 10 mM of phytic acid and 0.25 NaCl for 40 minutes, rinsed with deionized water for 1 minute and dried with nitrogen stream flow. Such phytic acid treated wires are identified by symbol Py for the phytic acid monolayer coating.

Polyelectrolyte multilayer coatings of 20 double layers (PEM2)₂₀ of polymer A1 (poly(styrenesulfonate-co-maleic acid) sodium salt) and polymer B2 (Poly(diallylamine-co-DADMAC)) are deposited on the phytic acid treated 316LVM stainless steel (SS316LVM) wires using the same layer-by-layer deposition method as described in Example 1. PEM2-H coatings of the heat treatment are obtained by treating PEM2 coated SS316LVM wires in a 170° C. vacuum oven for 17 hours. The treated wires are rinsed with deionized water (DIW) and dried with a nitrogen stream.

The PD-1 electrochemical corrosion testing results are shown in Figure Ex2 and Table Ex2. The treatment of phytic acid on SS316L fairly improved anticorrosion properties. Adding a 20 double layer PEM2 coatings on the Py treated SS316L greatly improved the anticorrosion properties. The heat treated PEM2 coatings (Py/(PEM-2)₂₀+heat) gave lowest corrosion current density (I_{corr}), highest corrosion potential (E_{corr}) and highest polarization resistance (Rₚ). The benefit of improved anticorrosion properties from heating the reactive PEM2 coatings can thus also be seen on phytic acid treated SS316LVM substrate.

TABLE EX 2
Data from Zplot-1, PD-1 and PS-2 tests for SS316L wires
uncoated and coated with PEM-2.

| | | | I_{corr} | | | t_{b}(700 | |
|---|---|---|---|---|---|---|---|
| | | E_{corr} | μA/ | Rₚ | E_{b} | mV) | |
| Wire ID | coatings | mV | cm² | kΩ*cm² | mV | hr | |
| Bare SS316L | No | −128 | 0.093 | 285 | 700 | 0 | |
| 16zs212PY | PY | −203 | 0.026 | 670 | No | 4 | h |
| 16zs200PW | Py/(PEM-2)₂₀ | 42 | 0.011 | 3650 | No | >14 | |
| 16zs200PWH | Py/(PEM-2)₂₀ + | 210 | 0.005 | 6180 | No | >14 | |
| | heat* | | | | | | |

*heat in 170° C. vacuum oven for 17 hours

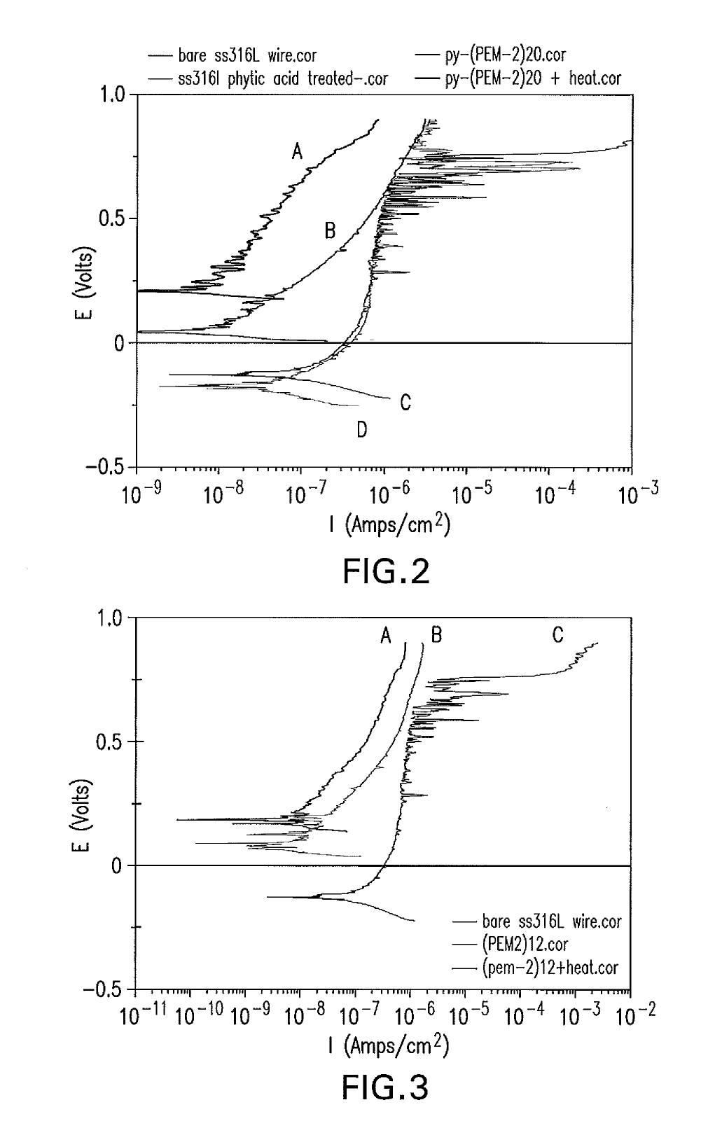

See FIG. 2: Potentiodynamic polarization curves from the PD-1 testing, bare SS316L wire (C curve), Py treated SS316L wire (D curve), Py treated SS316L wire coated with 20 double layer PEM-2 polymers (B curve), and Py treated SS316L wire coated with 20 double layers of PEM-2 polymers and heat treated at 170° C. for 3 hours (A curve)

### Example 3

### PEM2 Coatings with 12 Double Layers of Polymer A1 and Polymer B2 (16zs238PEM2W12AH)

Polyelectrolyte multilayer coatings comprising 12 instead of 20 double layers of polymer A1 and polymer B2 (PEM2)₁₂ were prepared on SS316LVM wires in the same ways as described in Example 1 (PEM-2)₁₂. Some of the (PEM-2)₁₂ coated SS316L wires were heat treated in vacuum oven at 170° C. for 3 hours ((PEM-2)₁₂+Heat). The PD-1 electrochemical corrosion testing results are shown in Figure Ex3 and Table Ex3. The heat treated PEM2 coatings gave low corrosion current density (I_{corr}) and high corrosion potential (E_{corr}) and polarization resistance (Rₚ). The benefit of improved anticorrosion properties from heat treatment in the PEM2 coatings can also be seen with reduced double layers number (12) and thus decreased coating film thickness.

TABLE Ex4
Data from PD-1 testing for PEM2 coatings with 12 double layers of
polymer A1 and Polymer B2

| | | E_{corr} | I_{corr} | Rₚ | E_{b} |
|---|---|---|---|---|---|
| Wire ID | Coatings | mV | μA/cm² | kΩ * cm² | mV |
| Bare SS316L | No | −128 | 0.093 | 285 | 700 |
| PEM2W12 | (PEM-2)₁₂ | 65 | 0.004 | 2270 | no |
| PEM2W12AH | /(PEM-2)₁₂ + Heat | 171 | 0.003 | 3790 | no |

See FIG. 3: Potentiodynamic polarization curves from the PD-1 testing, bare SS316L wire (C curve), SS316L wire coated with 12 double layer PEM-2 polymers (B curve), and SS316L wire coated with 12 double layers of PEM-2 polymers and treated in vacuum oven at 170 C for 3 hours (A curve).

### Example 4

### PEM2 Coatings with 12 Double Layers of Polymer A1 and Polymer B2 with Phytic Acid Pre-Treatment (16zs238PEM2W12BH)

Polyelectrolyte multilayer coatings comprising 12 instead of 20 double layers of polymer A1 and polymer B2 (PEM2)₁₂ were prepared on Py pre-treated SS316LVM wires in the same ways as described in Example 2 (Py/(PEM-2)₁₂). Some of the (PEM-2)₁₂ coated SS316L wires were heat treated in vacuum oven at 170° C. for 3 hours (Py(PEM-2)₁₂+Heat). The PD-1 electrochemical corrosion testing results are shown in Figure Ex4 and Table Ex4. The heat treated PEM2 coatings gave low corrosion current density (I_{corr}) and high corrosion potential (E_{corr}) and polarization resistance (Rₚ). The benefit of improved anticorrosion properties from heating the reactive PEM2 coatings can also be seen with reduced double layers number (12) and thus decreased coating film thickness.

TABLE Ex4
Data from PD-1 testing for PEM2 coatings with 12 double layers of
polymer A1 and Polymer B2

| | | E_{corr} | I_{corr} | Rₚ | E_{b} |
|---|---|---|---|---|---|
| Wire ID | coatings | mV | μA/cm² | kΩ * cm² | mV |
| Bare SS316L | No | −128 | 0.093 | 285 | 700 |
| PEM12W12B | Py/(PEM-2)₁₂ | 87 | 0.019 | 1261 | no |
| PEM12W12BH | Py/(PEM-2)₁₂ + | 152 | 0.002 | 8060 | no |
| | Heat | | | | |

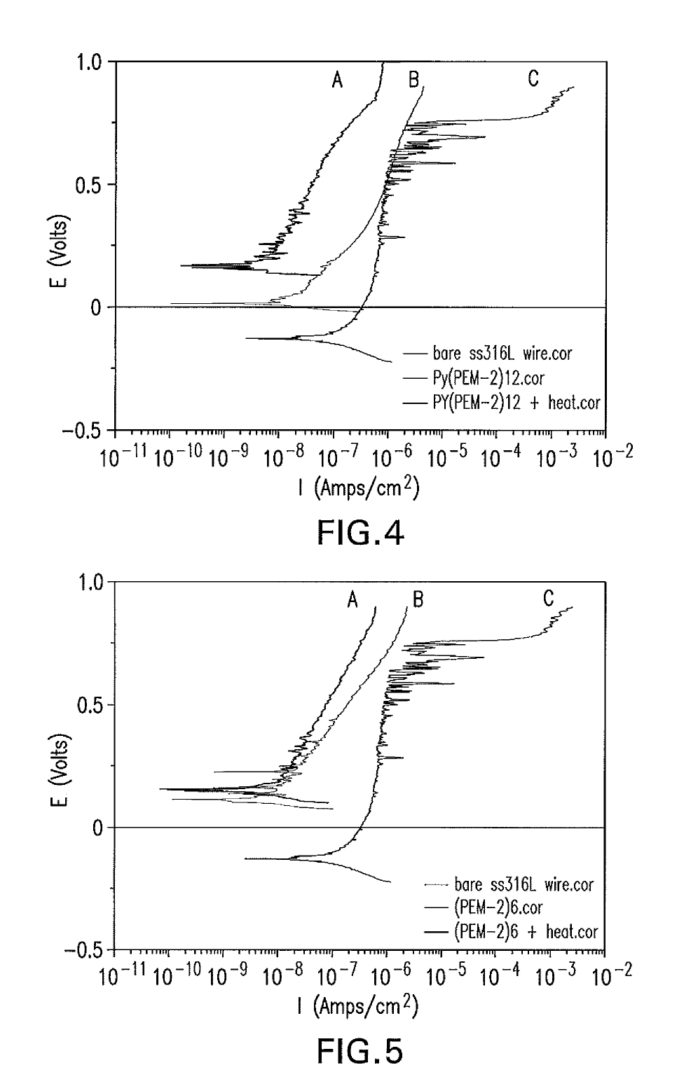

See FIG. 4: Potentiodynamic polarization curves from the PD-1 testing, bare SS316L wire (C curve), SS316L wire coated with 12 double layer PEM-2 polymers (B curve), and SS316L wire coated with 12 double layers of PEM-2 polymers and treated in vacuum oven at 170 C for 3 hours (A curve)

### Example 5

### PEM2 Coatings with 2 Double Layers of Polymer A1 and Polymer B2 (16zs233PEM2W6A)

Polyelectrolyte multilayer coatings comprising 6 instead of 20 double layers of polymer A1 and polymer B2 (PEM2)₆ are prepared on SS316LVM wires in the same ways as described in Example 1 (PEM-2)₆. Some of the (PEM-2)₆ coated SS316L wires are heat treated in vacuum oven at 170° C. for 3 hours ((PEM-2)₆+Heat). The PD-1 electrochemical corrosion testing results are shown in Figure Ex5 and Table Ex5. The heat treated PEM2 coatings gave low corrosion current density (I_{corr}) and high corrosion potential (E_{corr}) and polarization resistance (Rₚ). The benefit of improved anticorrosion properties from heating the reactive PEM2 coatings can also be seen with reduced double layers number (6) and thus decreased coating film thickness.

TABLE Ex5
Data from PD-1 testing

| | | E_{corr} | I_{corr} | Rₚ | E_{b} |
|---|---|---|---|---|---|
| Wire ID | coatings | mV | μA/cm² | kΩ * cm² | mV |
| Bare SS316L | No | −128 | 0.093 | 285 | 700 |
| PEM2W6 | (PEM-2)₆ | 112 | 0.008 | 3400 | No |
| PEM2W6 + heat | (PEM-2)₆ + heat | 148 | 0.003 | 4240 | No |

See FIG. 5: Potentiodynamic polarization curves from the PD-1 testing, bare SS316L wire (C curve), SS316L wire coated with 6 double layer PEM-2 polymers (B curve), and SS316L wire coated with 6 double layers of PEM-2 polymers and treated in vacuum oven at 170 C for 3 hours (A curve)

### Example 6

### PEM2 Coatings with 2 Double Layers of Polymer A1 and Polymer B2 (16zs233PEM2W2A)

Polyelectrolyte multilayer coatings comprising 2 instead of 20 double layers of polymer A1 and polymer B2 (PEM2)₂ were prepared on SS316LVM wires in the same ways as described in Example 1 (PEM-2)₂. Some of the (PEM-2)₂ coated SS316L wires were heat treated in vacuum oven at 170° C. for 3 hours ((PEM-2)₂+Heat). The PD-1 electrochemical corrosion testing results are shown in Figure Ex6 and Table Ex6. The heat treated PEM2 coatings gave low corrosion current density (I_{corr}) and high corrosion potential (E_{corr}) and polarization resistance (Rₚ). The benefit of improved anticorrosion properties from heating the reactive PEM2 coatings can also be seen with reduced double layers number (2) and thus decreased coating film thickness.

TABLE Ex6
Data from PD-1 testing

| | | E_{corr} | I_{corr} | Rₚ | E_{b} |
|---|---|---|---|---|---|
| Wire ID | coatings | mV | μA/cm² | kΩ * cm² | mV |
| Bare SS316L | No | −128 | 0.093 | 285 | 700 |
| PEM2W2 | (PEM-2)₂ | 127 | 0.002 | 1140 | No |
| PEM2W2-Heat | (PEM-2)₂ + heat | 218 | 0.002 | 5550 | No |

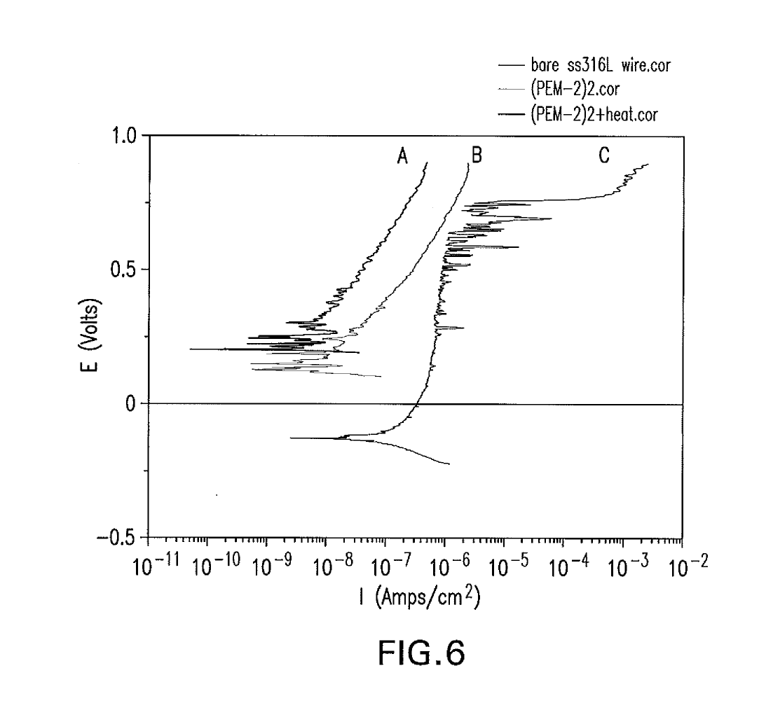

See FIG. 6: Potentiodynamic polarization curves from the PD-1 testing, bare SS316L wire (C curve), SS316L wire coated with 2 double layer PEM-2 polymers (B curve), and SS316L wire coated with 6 double layers of PEM-2 polymers and treated in vacuum oven at 170 C for 3 hours (A curve)

What we claim are:

1. A polyelectrolyte complex which complex comprises
polyelectrolytes (A) and (B), wherein polyelectrolyte (A) is an anionic polyelectrolyte containing strongly and negatively charged groups (Aₛ) and weak acid groups (A_{w}) and polyelectrolye (B) is a cationic polyelectrolyte containing strongly and positively charged groups (Bₛ) and weak base groups (B_{w}),
wherein groups (A_{w}) and groups (B_{w}) are reactible with each other to form covalent bonds.

2. The polyelectrolyte complex according to claim 1, wherein the Bₛ group is a quaternized ammonium, sulfonium or phosphonium group and the B_{w} group is a primary, secondary or tertiary amine group.

3. The polyelectrolyte complex according to claim 1, wherein the Aₛ group is a sulfonic, sulfate, phosphate, hydrogen phosphate or phosphoric acid groups and the A_{w} group is a carboxylic acid group.

4. The polylectrolyte complex according to claim 1, wherein the polyelectrolyte (A) is a synthetic polymer and contains repeat units formed from a first anionic monomer containing an Aₛ group wherein the first monomers are selected from the group consisting of styrene sulfonic acids, vinylsulfonic acid, allyl sulfonic acid, (meth)acrylamidopropyl sulfonic acid, vinyl phosphonic acid and salts thereof
and
a second anionic monomer containing A_{w} groups are selected from (meth)acrylic acid, maleic acid or anhydride, itaconic acid or anhydride, crotonic acid and mixtures and salts thereof.

5. The polylectrolyte complex according to claim 1, wherein the polyelectrolyte (B) Is a synthetic polymer and contains repeat units formed from a first cationic monomer containing a Bₛ group wherein the first monomers are selected from the group consisting of diallyldimethyl ammonium chloride (DADMAC), diallyldimethyl ammonium bromide, diallyldimethyl ammonium sulfate, diallyldimethyl ammonium phosphates, diethylallyl dimethyl ammonium chloride, diallyl di(beta-hydroxyethyl) ammonium chloride, and diallyl di(beta-ethoxyethyl) ammonium chloride, dimethallyldimethyl ammonium chloride, dimethylaminoethyl (meth)acrylate methyl chloride quaternary, diethylaminoethyl (meth)acrylate methyl chloride quaternary, dimethylaminoethyl (meth)acrylate dimethylsulfate quaternary, dimethylaminoethyl (meth)acrylate benzyl chloride quaternary,
and
a second cationic monomer containing B_{w} groups and the second monomers are selected from diallyamine, vinylimidazole, vinyl pyridine, vinyl amine (obtained by hydrolysis of vinylalkylamide polymers), dimethylaminoethyl (meth)acrylate and salts thereof.

6. The polyelectrolyte complex according to claim 3, wherein the anionic polyelectrolyte (A) is poly(styrenesulfonate-co-maleic acid), poly(styrenesulfonate-co-methacrylic acid), poly(styrenesulfonate-co-acrylic acid) or poly(styrenesulfonate-co-itaconic acid).

7. The polyelectrolyte complex according to claim 2, wherein the polyelectrolyte (B) is a copolymer of diallyldimethylammonium chloride (DADMAC) and diallylamine (DAA).

8. A coated metal substrate comprising a
a) metal substrate,
b) a coating on said substrate comprising a polyelectrolyte complex according to claim 1
and
c) optionally, further comprising an antimicrobial agent.

9. The coated metal substrate according to claim 8, wherein the Bₛ group is a quaternized ammonium, sulfonium or phosphonium group, and the B_{w} group is a primary, secondary or tertiary amine group.

10. The coated metal substrate according to claim 8, wherein the Aₛ group is a sulfonic, sulfate, phosphate, hydrogen phosphate or phosphoric acid groups and the A_{w} group is a carboxylic acid group.

11. The coated metal substrate according to claim 8, wherein the metal substrate is at least a part of a medical device or implant.

12. A method of protecting a metal substrate from corrosion comprising the steps of
i) applying to the substrate a polyelectrolyte (A) and a polyelectrolyte (B) to form a complex according to claim 1,
ii.) optionally, applying an after-treatment to the applied complex to form covalent bonds between groups (A_{w}) and groups (B_{w}),
and
iii.) optionally, contacting the metal substrate, incorporation into either the polyelectrolyte (A) and/or (B) or contacting the applied complex with an antimicrobial agent.

13. The method according to claim 12, wherein the Bₛ group is a quaternized ammonium, sulfonium or phosphonium group and the B_{w} group is a primary, secondary or tertiary amine group.

14. The method according to claim 12, wherein the Aₛ group is a sulfonic, sulfate, phosphate, hydrogen phosphate or phosphoric acid groups and the A_{w} group is a carboxylic acid group.

15. The method according to claim 8, wherein the polyelectrolyte (A) and polyelectrolyte (B) are applied sequentially to the substrate via layer-by-layer deposition, wherein the sequential application is optionally repeated.

16. A kit of parts for the manufacture of a corrosion resistant metal substrate, comprising a first part (A) comprising an anionic polyelectrolyte containing strongly and negatively charged groups (Aₛ) and weak acid groups (A_{w}) and a second part (B) comprising a cationic polyelectrolyte containing strongly and positively charged groups (Bₛ) and weak base groups (B_{w})
wherein groups (A_{w}) and groups (B_{w}) are reactible with each other to form covalent bonds,
and an optional third part comprising an antimicrobial agent,
which parts when applied to the metal substrate form a coated metal substrate according to claim 8.

17. The kit of parts according to claim 16, wherein the Bₛ group is a quaternized ammonium, sulfonium or phosphonium group and the B_{w} group is a primary, secondary or tertiary amine group.

18. The kit of parts according to claim 16, wherein the Aₛ group is a sulfonic, sulfate, phosphate, hydrogen phosphate or phosphoric acid groups and the A_{w} group is a carboxylic acid group.
